(19) United States
(12) Patent Application Publication
(10) Pub. No.: US 2026/0045846 A1
(43) Pub. Date: Feb. 12, 2026

(54) STATOR FOR ELECTRIC MOTOR HAVING INSULATION SLEEVES TO CONNECT LAMINATED CORE

(71) Applicant: Schaeffler Technologies AG & Co. KG, Herzogenaurach (DE)

(72) Inventor: Patricio Mariano Ramos Merino, San Pedro Choluda (MX)

(73) Assignee: Schaeffler Technologies AG & Co. KG, Herzogenaurach (DE)

(21) Appl. No.: 18/795,381

(22) Filed: Aug. 6, 2024

(51) Int. Cl. H02K 3/34; H02K 1/28; H02K 3/30; H02K 15/02; H02K 15/10

(52) U.S. Cl. CPC H02K 3/34; H02K 1/28; H02K 3/30; H02K 15/021; H02K 15/10

(57) ABSTRACT

An electric motor includes a rotor and a stator. The stator includes laminated steel plates assembled in a stack, with axially extending openings that extend through the stack for receiving stator coil wires. Insulating inserts are provided, with one extending through each of the openings that receives a stator coil wire. The insulating inserts are formed as plate connecting inserts having a hollow body with a coil wire receiving channel, and a first end is slidably inserted into one of the axially extending openings and a second end with a head is seated against an axially outermost one of the plates. A first subset of the inserts are inserted with the respective heads on a first axial side of the stack, and a second subset of the inserts are inserted with the respective heads on a second axial side. Stator coil wires extend through the coil wire receiving channels.

### TECHNICAL FIELD

The disclosure relates to electric motors, and particularly to the stator of an electric motor. More particularly, the disclosure relates to coil insulator structures for the stator.

### BACKGROUND

The stator of an electric motor may be composed of steel laminations, and these are commonly fixed together in two ways, interlocking and welding. Interlocking is carried out by a protrusion in the lamination that works in an interlocking manner (like a Lego) where two laminations are fixed when pushed together. Welding is used at the outer diameter of the stator, and it is more of a permanent fixture of the laminations. Sometimes, both interlocking and welding are used. However, this only holds together the center and the outer diameter of the stack of steel laminations and not the inner diameter because the interlocking and welding are never done close to the inner diameter. This results in an issue that happens in many stators—the separation of the laminations at the inner diameter, more specifically the teeth of the stators. Examples of such separations are shown on FIGS. 1 and 2, where prior art stators 2 are shown and the separations are indicated at 4. This negatively effects performance.

It would be desirable to provide an arrangement that eliminates or reduces this issue without affecting performance or other electromagnetic characteristics of the stator.

### SUMMARY

In one aspect, an electric motor is provided which includes a rotor and a stator, with the rotor being mounted for rotation within the stator. The stator includes a plurality of laminated steel plates assembled in a stack, with the steel plates including a plurality of axially extending openings that extend through the stack for receiving stator coil wires. These openings intersect the inner periphery of the stator. A plurality of insulating inserts are provided, with one of the insulating inserts extending through each of the openings that is adapted to receive at least one of the stator coil wires. At least some of the insulating inserts, and in one embodiment, all of the insulating inserts are plate connecting inserts, and the plate connecting inserts are each formed of a polymeric material and include a hollow body having an axially extending coil wire receiving channel, and a first end that is adapted to be slidably inserted into one of the axially extending openings and a second end with a head that is adapted to be seated against an axially outermost one of the laminated steel plates that form the stack. At least a first subset of the plate connecting inserts are inserted such that the respective heads are on a first axial side of the stack, and a second subset of the plate connecting inserts are inserted such that the respective heads are on a second axial side of the stack. Stator coil wires extends through the axially extending coil wire receiving channels of the plate connecting inserts.

In one embodiment, the plurality of plate connecting inserts are inserted in the axially extending openings in an alternating arrangement with respective heads of alternate ones of the plurality of insulating inserts being on the first axial side of the stack.

Depending on the type of coils and how they are wound, the hollow bodies of the plate connecting inserts can be open to the inner periphery of the stator.

In one embodiment, the plate connecting inserts are molded of a polymeric material.

In one embodiment, the channel has a rectangular cross-section. However, other cross-sectional shapes are possible.

In one embodiment, the plate connecting inserts are bonded or adhered to the laminated steel plates. The plate connecting inserts can also have an interference fit with the respective axially extending openings. It is possible to have both the adhesive and the interference fit. One or more of these measures along with the stator coil wires being bent where it enters and/or exits the opening at the head of the plate connecting insert reduces or prevents the possibility of the steel plates in the stack delaminating.

In one embodiment, the plate connecting inserts extend past both the first axial side and the second axial side of the stack.

In one embodiment, each of the heads is generally rectangular and may optionally include concave walls that extend from a plate contact side of the head to a coil wire opening side of the head. However, the specific head configuration can vary based on the particular application.

In another aspect, a method of assembling a stator for an electric motor is provided, with the method comprising:
A) laminating a plurality of steel plates together into a stack, the steel plates including a plurality of axially extending openings that extend through the stack for receiving stator coil wires;
B) inserting a plurality of insulating inserts into the axially extending openings, one of the insulating inserts extending through each of the openings that is adapted to receive at least one of the stator coil wires;
C) forming at least some of the insulating inserts as plate connecting inserts, and the plate connecting inserts are each formed of a polymeric material and include a hollow body having an axially extending coil wire receiving channel, and a first end that is adapted to be slidably inserted into one of the axially extending openings and a second end with a head that is adapted to be seated against an axially outermost one of the laminated steel plates that form the stack;
D) wherein the inserting step includes inserting a first subset of the plate connecting inserts such that the respective heads are on a first axial side of the stack and inserting a second subset of the plate connecting inserts such that the respective heads are on a second axial side of the stack; and
E) installing stator coil wires through the axially extending coil wire receiving channels of the plate connecting inserts.

In one embodiment of the method, the plurality of insulating inserts all comprise the plate connecting inserts.

In one embodiment, the method further comprises the inserting including inserting the plurality of insulating inserts in the axially extending openings in an alternating arrangement with respective heads of alternate ones of the plurality of insulating inserts being on the first axial side of the stack.

In one embodiment of the method, the plate connecting inserts are molded of a polymeric material.

In one embodiment, the method further comprises adhering or bonding the plate connecting inserts to the laminated steel plates.

In one embodiment of the method, the plate connecting inserts have an interference fit with the respective axially extending openings.

In one embodiment, the method further comprises inserting the plate connecting inserts so that the head end and the insertion end extend past the first axial side and the second axial side of the stack.

One or more of the above features can be combined to provide a stator as well as an electric motor having such a stator with improved performance.

### BRIEF DESCRIPTION OF THE DRAWING(S)

The foregoing Summary as well as the following Detailed Description will be best understood when read in conjunction with the appended drawings, which illustrate an embodiment according to the disclosure. In the drawings:

FIGS. 1 and 2 are photographs of prior art stator assemblies showing failures where the steel laminations of the stator stack have separated and delaminated.

FIG. 3 is a schematic view of an electric motor having a rotor and a stator in accordance with the present disclosure.

FIG. 4 is a partial perspective view of one axial end of the stator of the electric motor of FIG. 3 in accordance with the present disclosure.

FIG. 5 is a partial perspective view of an opposite axial end of the stator for the motor shown in FIG. 4.

FIG. 6 is a perspective view of an insulating insert used in connection with the stator of the electric motor shown in FIGS. 3-5.

FIG. 7 is an elevational view of a head and of the insulating insert shown in FIG. 6.

FIG. 8 is a partial perspective view of the insulating insert shown in FIGS. 6 and 7 showing the configuration of the head end of the insulating insert.

FIG. 9 is an elevational view of the head end of the insulating insert shown in FIGS. 6-8.

FIG. 10 is a view showing the head end of a second embodiment of an insulating insert similar to the insulating insert shown in FIGS. 3-9 in which one side of the receiving channel formed by the insulating insert is open to an inner periphery of the stator.

### DETAILED DESCRIPTION

Certain terminology is used in the following description for convenience only and is not limiting. “Axial” refers to a direction along an axis. A reference to a list of items that are cited as “at least one of a, b, or c” (where a, b, and c represent the items being listed) means any single one of the items a, b, or c, or combinations thereof. The terms “generally”, “about” and “approximately” are to be construed as within 10% of a stated value or ratio. The terminology includes the words specifically noted above, derivatives thereof, and words of similar import.

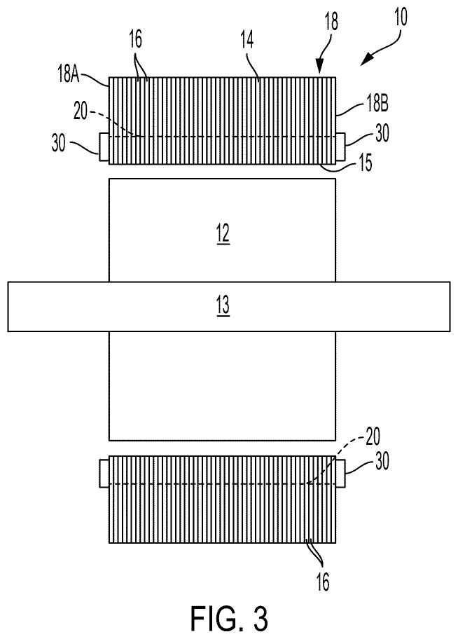

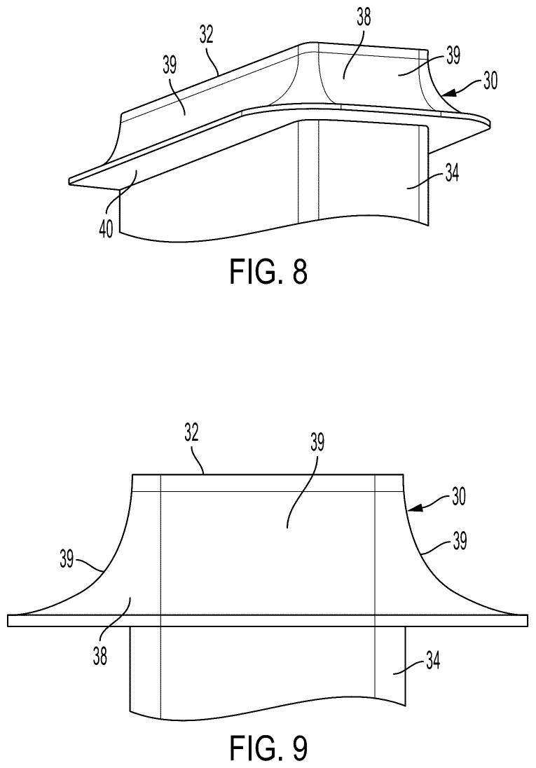

Referring to FIGS. 3-9, an electric motor 10 in accordance with the present disclosure is shown. The electric motor 10 includes a rotor 12 as well as a stator 14, with the rotor 12 being mounted for rotation within the stator 14. As shown in detail in FIG. 3, the rotor 12 can be mounted on a shaft 13 which is supported by bearings, not shown.

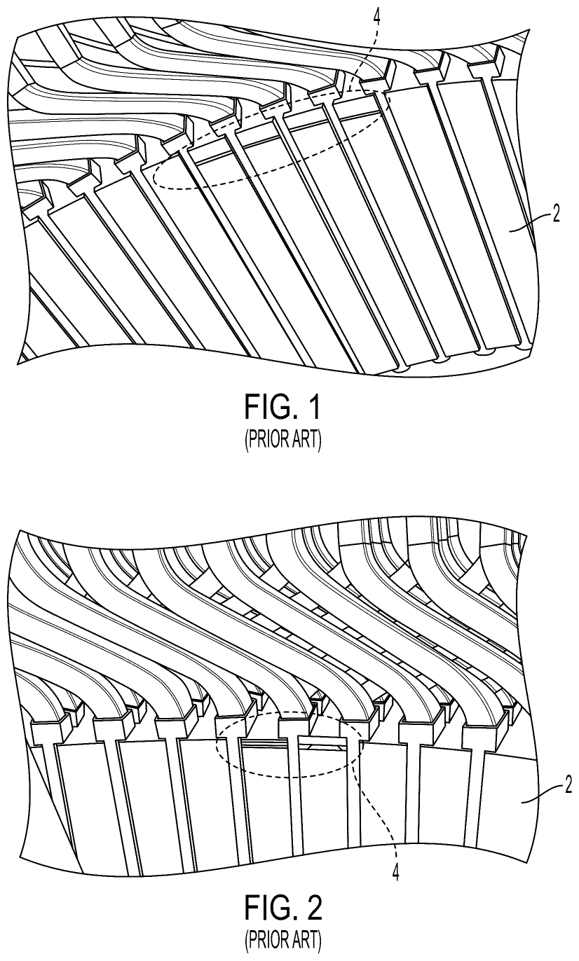

The stator 14 includes a plurality of laminated steel plates 16 that are assembled into a stack 18. The steel plates 16 include a plurality of axially extending openings 20 that extend through the stack 18 for receiving stator coil wires 22. The axially extending openings 20 extend to an inner periphery 15 of the stator 14 and are adapted to receive stator coil wires 22 in a similar manner as shown in the prior art FIGS. 1 and 2.

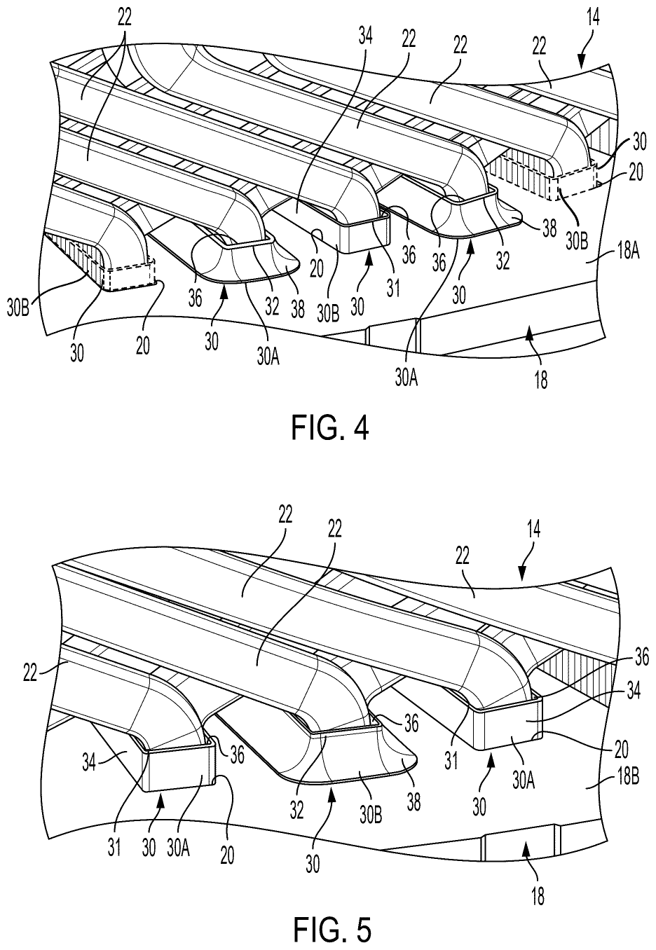

As shown in detail in FIGS. 4 and 5, a plurality of insulating inserts 30 are provided, with one of the insulating inserts 30 extending through each of the openings 20 that is adapted to receive at least one of the stator coil wires 22. In accordance with the present disclosure, at least some of these insulating inserts 30 are plate connecting inserts 30. In the illustrated embodiment, each of the insulating inserts 30 is a plate connecting inserts 30. However, it is possible that other types of insulating inserts may be provided in some of the axially extending openings 20, such as the prior known paper insulators.

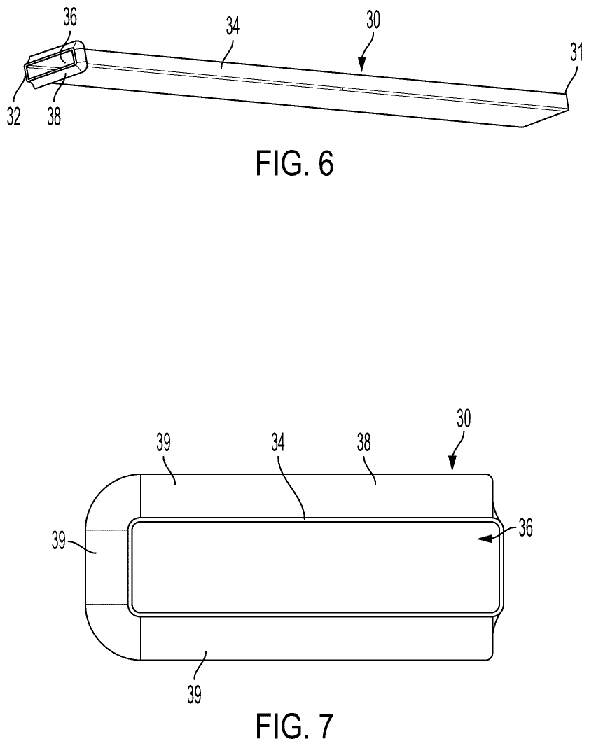

As shown in detail in FIGS. 6-9, the plate connecting inserts 30 are each formed of a polymeric material and include a hollow body 34 having an axially extending coil wire receiving channel 36. A first end 31 of the hollow body 34 is adapted to be slidably inserted into one of the axially extending openings 20, and a second end 32 (the head end) of the hollow body 34 includes a head 38 that is adapted to be seated against an axially outermost one of the steel plate 16 that form the stack 18.

In one embodiment, each of the heads 38 is generally rectangular and may optionally include concave walls 39 on one or more sides that extend from a plate contact side 40 of the head to a coil wire opening side of the head 38 (at the second end 32). The concave walls 39 provide reinforcement and stiffness to the head while reducing the volume of material needed to mold the plate connecting insert 30. However, the specific head configuration can vary based on the particular application.

As shown in FIGS. 4 and 5, at least a first subset 30A of the plate connecting inserts 30 are inserted such that the respective heads 38 are on a first axial side 18A of the stack 18, and a second subset 30B of the plate connecting inserts 30 is inserted such that the respective heads 38 are on a second axial side 18B of the stack 18.

As shown, stator coil wires 22 extend through the axially extending coil wire receiving channel 36 of the plate connecting inserts 30. The stator coil wires 22 may be installed in the known manner.

In one arrangement, the plurality of insulating inserts 30 all comprise the plate connecting inserts 30. Further, in the illustrated embodiment, the plurality of plate connecting inserts 30 are inserted in the axially extending openings 20 in an alternating arrangement with the respective heads 38 of alternate ones of the plurality of insulting inserts 30 that form the first subset 30A being on the first axial side 18A of the stack 18. The second subset 30B of the plate connecting inserts 30 would therefore have their respective heads 38 on the second axial side 18B of the stack 18. This is indicated in FIGS. 4 and 5 which show opposite axial sides of a portion of the same stator 14. While an alternating arrangement of the first and second subsets 30A, 30B of the plate connecting inserts 30 is illustrated, those of ordinary skill in the art will recognize that other arrangements may also be provided, such as having the first subset 30A of the plate connecting inserts 30 being inserted in adjacent pairs and spaced apart by adjacent pairs of ones of the plate connecting inserts 30 of the second subset 30B. Other arrangements could also be provided along with the possibility of at least some of the axially extending openings 20 that extend through the stack 18 including other types of insulating inserts rather than the plate connecting inserts 30.

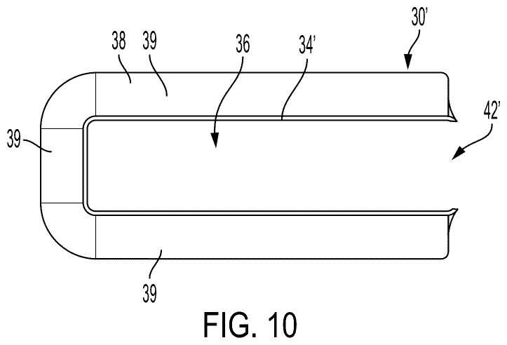

As shown in FIG. 10, in an alternate embodiment of the plate connecting insert 30′, the hollow body 34′ may be open to the inner periphery of the stator 14, for example by having an opening 42′ in one side of the hollow body 34′. All other features of the plate connecting insert 30′ are the same as discussed above in connection with the plate connecting insulating insert 30.

In one aspect, the plate connecting inserts 30, 30′ can be molded of a polymeric material, such as PA 66 or any other suitable polymeric material, and are pre-formed for later assembly with the stack 18 of the laminated steel plate 16.

The channel 36 in each of the plate connecting inserts 30 preferably has a rectangular cross-section as shown in FIG. 7 for receiving the stator coil wires 22. However, other cross-sections may be utilized.

In order to assist in holding the plurality of laminated steel plates 16 together and preventing or reducing the possibility of delamination, the plate connecting inserts 30 may have an interference fit with the respective axially extending openings 20 which would allow them to be pressed into position and provide a holding force for holding the plurality of laminated steel plates 16 together. Further, varnish or another adhesive that is placed on the stator 14 in order to hold the stator coil wires 22 in position within the insulating inserts 30 can also be used to some extent in holding the plurality of laminated steel plates 16 together by preventing movement of the insulating inserts 30 once they have been installed. The varnish or other adhesive may at least partially bond or adhere the plate connecting inserts 30 to the laminated steel plates 18. Further, some force is also applied to the head 38 of the plate connecting insert 30, 30′ by the stator coil wires 22 once installed and bent to travel along their further path, for example as can be understood from the arrangement shown in FIGS. 4 and 5. This arrangement of the coil wires with bends on both of the first and second axial sides 18A, 18B of the stack 18 applies a force on the respective heads 38 of the plurality of plate connecting inserts 30 on each of the axial sides 18A, 18B. Accordingly, a combination of one or more of the above is used in accordance with the present disclosure in order to press the plurality of laminated steel plates 16 together in order to eliminate or reduce the issue with separations in the laminations particularly around the inner periphery of the stator 14.

As will be understood by those of ordinary skill in the art, the outer periphery of the stator can have the laminated steel plates 16 connected to one another by interlocking and/or welding as discussed above in the Background.

As shown in detail in FIGS. 4 and 5, preferably the plate connecting inserts 30 extend past both the first axial side 18A and the second axial side 18B of the stack 18.

In another aspect, a method of assembling the stator 14 for the electric motor 10 is provided using the plate connecting inserts 30 which are preformed. The method includes:
A) laminating a plurality of steel plates 16 together into a stack 18, with the steel plates 16 including a plurality of axially extending openings 20 that extend through the stack 18 for receiving stator coil wires 22;
B) inserting a plurality of the insulating inserts 30 into the axially extending openings 20, with one of the insulating inserts 30 extending through each of the openings 20 that is adapted to receive at least one of the stator coil wires 22;
C) forming at least some of the insulating inserts 30 as plate connecting inserts 30, and the plate connecting inserts 30 are each formed of a polymeric material and include the hollow body 34 having the axially extending coil wire receiving channel 36 and the first end 31 that is adapted to be slidably inserted into one of the axial extending openings 20 and the second end 32 with the head 38 that is adapted to be seated against an axial outermost one of the laminated steel plates 16 that form the stack 18;
D) in the method according to the disclosure, the inserting includes inserting the first subset 30A of the plate connecting inserts 30 such that the respective heads 38 are on the first axial side 18A of the stack 18 and inserting the second subset 30B of the plate connecting inserts 30 such that the respective head 38 are on the second axial side 18B of the stack 18; and
E) installing the stator coil wires 22 through the axially extending coil wire receiving channels 36 of the plate connecting inserts 30.

The method may include the plurality of insulating inserts 30 all comprising the plate connecting inserts 30.

Further, the method may include the inserting including inserting the plurality of plate connecting inserts 30 in the axially extending openings 20 in an alternating arrangement such that the heads 38 of alternate ones of the plurality of the insulating inserts 30 (i.e., the first subset 30A) are on the first axial side 18A of the stack 18, and the heads 38 of the second subset 30B of the plate connecting inserts 30 are on the second axial side 18B. Here it is also possible to provide different arrangements for the first subset 30A of the plate connecting inserts 30 and the second subset 30b of the plate connecting inserts 30, such as inserting the plate connecting inserts 30 in the first subset 30A in adjacent pairs alternating with adjacent pairs of the plate connecting inserts 30 of the second subset 30B. It is also possible to have at least some of the axially extending openings 20 insulated with other types of insulating inserts.

The method may further include molding the plate connecting inserts 30 from a polymeric material.

Further, the method can include adhering or bonding the plate connecting inserts 30 to the laminated steel plates 16. This can be done during the typical varnishing or adhering process for connecting the stator coil wires 22 in position.

The method may further include the plate connecting inserts 30 having an interference fit with the respective axially extending openings 20. This provides additional force for holding the laminated steel plates 16 together in order to prevent separation.

The method may further include inserting the plate connecting inserts 30 such that the head 38 and the first, insertion end, 31 extend past the first axial side 18A and the second axial side 18B of the stack 18.

The method may further include connecting the laminated steel plates 16 at the outer periphery by interlocking and/or welding.

Using one or more of the above features provides a stator 14 as well as an electric motor 10 having such a stator 14 with improved performance based on the use of the plate connecting inserts 30 in order to prevent separation of the plurality of laminated steel plates 16 that form the stack 18.

Having thus described the present embodiments in detail, it is to be appreciated and will be apparent to those skilled in the art that many physical changes, only a few of which are exemplified in the detailed description of the disclosure, could be made without altering the inventive concepts and principles embodied therein. It is also to be appreciated that numerous embodiments incorporating only part of the preferred embodiment are possible which do not alter, with respect to those parts, the inventive concepts and principles embodied therein.

The present embodiment and optional configurations are therefore to be considered in all respects as exemplary and/or illustrative and not restrictive, the scope of the disclosure being indicated by the appended claims rather than by the foregoing description, and all alternate embodiments and changes to this embodiment which come within the meaning and range of equivalency of said claims are therefore to be embraced therein.

### LOG OF REFERENCE NUMERALS

2 stator-prior art
4 separations-prior art
10 electric motor
12 rotor
13 shaft
14 stator
15 inner periphery
16 laminated steel plate
18 stack
18A first axial side
18B second axial side
20 opening
22 stator coil wire
30, 30′ insulating plate connecting insert
30A first subset
30B second subset
31 first end
32 second end
34, 34′ hollow body
36 coil wire receiving channel
38 head
40 plate contact side of head 38
42 opening

1. An electric motor, comprising:
a rotor; and
a stator, the rotor being mounted for rotation within the stator, the stator including
a plurality of laminated steel plates assembled in a stack, the steel plates including a plurality of axially extending openings that extend through the stack for receiving stator coil wires,
a plurality of insulating inserts, one of the insulating inserts extending through each of the openings that is adapted to receive at least one of the stator coil wires, and
at least some of the insulating inserts are plate connecting inserts, and the plate connecting inserts are each formed of a polymeric material and include a hollow body having an axially extending coil wire receiving channel, and a first end that is adapted to be slidably inserted into one of the axially extending openings and a second end with a head that is adapted to be seated against an axially outermost one of the laminated steel plates that form the stack, with at least a first subset of the plate connecting inserts being inserted such that the respective heads are on a first axial side of the stack and a second subset of the plate connecting inserts being inserted such that the respective heads are on a second axial side of the stack; and
stator coil wires extending through the axially extending coil wire receiving channels of the plate connecting inserts.

2. The electric motor of claim 1, wherein the plurality of insulating inserts all comprise the plate connecting inserts.

3. The electric motor of claim 2, wherein the plurality of plate connecting inserts are inserted in the axially extending openings in an alternating arrangement with respective heads of alternate ones of the plurality of insulating inserts being on the first axial side of the stack.

4. The electric motor of claim 1, wherein the axially extending openings extend to the inner periphery of the stator, and the hollow bodies of the plate connecting inserts are open to the inner periphery of the stator.

5. The electric motor of claim 1, wherein the plate connecting inserts are molded of a polymeric material.

6. The electric motor of claim 1, wherein the channel has a rectangular cross-section.

7. The electric motor of claim 1, wherein plate connecting inserts are bonded or adhered to the laminated steel plates.

8. The electric motor of claim 1, wherein the plate connecting inserts have an interference fit with the respective axially extending openings.

9. The electric motor of claim 1, wherein the plate connecting inserts extend past both the first axial side and the second axial side of the stack.

10. The electric motor of claim 1, wherein each of the heads is generally rectangular and has concave walls that extend from a plate contact side of the head to a coil wire opening side of the head.

11. A method of assembling a stator for an electric motor, the method comprising:
laminating a plurality of steel plates together into a stack, the steel plates including a plurality of axially extending openings that extend through the stack for receiving stator coil wires;
inserting a plurality of insulating inserts into the axially extending openings, one of the insulating inserts extending through each of the openings that is adapted to receive at least one of the stator coil wires;
forming at least some of the insulating inserts as plate connecting inserts, and the plate connecting inserts are each formed of a polymeric material and include a hollow body having an axially extending coil wire receiving channel, and a first end that is adapted to be slidably inserted into one of the axially extending openings and a second end with a head that is adapted to be seated against an axially outermost one of the laminated steel plates that form the stack;
wherein the inserting includes inserting a first subset of the plate connecting inserts such that the respective heads are on a first axial side of the stack and inserting a second subset of the plate connecting inserts such that the respective heads are on a second axial side of the stack; and
installing stator coil wires through the axially extending coil wire receiving channels of the plate connecting inserts.

12. The method of claim 11, wherein the plurality of insulating inserts all comprise the plate connecting inserts.

13. The method of claim 12, the method further comprises the inserting including inserting the plurality of insulating inserts in the axially extending openings in an alternating arrangement with respective heads of alternate ones of the plurality of insulating inserts being on the first axial side of the stack.

14. The method of claim 11, wherein the plate connecting inserts are molded of a polymeric material.

15. The method of claim 11, further comprising adhering or bonding the plate connecting inserts to the laminated steel plates.

16. The method of claim 11, wherein the plate connecting inserts have an interference fit with the respective axially extending openings.

17. The method of claim 11, further comprising inserting the plate connecting inserts so that the first and second ends extend past the first axial side and the second axial side of the stack, respectively.
